(19) United States
(12) Patent Application Publication
(10) Pub. No.: US 2025/0292960 A1
(43) Pub. Date: Sep. 18, 2025

(54) MULTILAYER CERAMIC CAPACITOR

(71) Applicant: TAIYO YUDEN CO., LTD., Tokyo (JP)

(72) Inventor: Ayumi MATSUOKA, Takasaki-shi (JP)

(21) Appl. No.: 19/224,458

(22) Filed: May 30, 2025

Related U.S. Application Data
(63) Continuation of application No. PCT/JP2023/043748, filed on Dec. 7, 2023.

(30) Foreign Application Priority Data
Dec. 27, 2022 (JP) 2022-210805

(51) Int. Cl. H01G 4/008; H01G 4/12; H01G 4/232; H01G 4/248; H01G 4/30

(52) U.S. Cl. CPC H01G 4/008; H01G 4/12; H01G 4/232; H01G 4/248; H01G 4/30

(57) ABSTRACT

A multilayer ceramic capacitor in an embodiment includes a multilayer chip, which includes a plurality of dielectric layers formed of a dielectric ceramic and internal electrodes disposed on upper and lower surfaces of each of the dielectric layers and containing nickel, a noble metal element, and a base metal element that forms an alloy with nickel, wherein the internal electrodes are alternately extracted and exposed to form a pair of extraction faces facing each other, and which includes external electrodes that electrically interconnect the internal electrodes extracted onto the extraction faces of the multilayer chip, wherein, in the internal electrodes observed on a cross-section perpendicular to the extraction faces, 10 or more segregation sites of the base metal element per layer are detected in a region located in a capacitance-forming part in which the internal electrodes adjacent to each other in a lamination direction overlap.

### TECHNICAL FIELD

The present invention relates to a multilayer ceramic capacitor.

### BACKGROUND ART

In a high-frequency communication system, such as a mobile phone, a small-sized large-capacitance multilayer ceramic capacitor is required to provide further functionality.

To reduce the size and increase the capacitance of a multilayer ceramic capacitor, it is effective to reduce the thickness of a dielectric layer and an internal electrode and increase the number of laminated layers. However, a reduction in the thickness of a dielectric layer means a reduction in the distance between internal electrodes adjacent to each other in a lamination direction, which may result in a reduction in the electrical insulation property between the internal electrodes when the capacitor is used. Thus, to reduce the thickness of a dielectric layer, it is important to maintain electrical insulation property between internal electrodes and inhibit a decrease in insulation reliability.

As a scheme for ensuring insulation reliability when a dielectric layer is thinned, Patent Literature 1 discloses that a thin metal film layer containing at least one type selected from Au, Pt, Pd, Ag, and Cu is formed between a dielectric layer and an internal electrode layer composed mainly of Ni in a multilayer ceramic capacitor.

Furthermore, in a multilayer ceramic capacitor, as other techniques for containing a different type of metal element in an internal electrode composed mainly of Ni, there have been reported a technique of forming an internal electrode composed mainly of Ni and further containing a noble metal (Patent Literature 2 to Patent Literature 4) and a technique of forming an internal electrode using a material in which the entire surface of Ni is coated with Si as an alloying element (Patent Literature 5).

### BACKGROUND ART LITERATURE

### Patent Literature

Patent Literature 1: Japanese Unexamined Patent Application Publication No. 2003-7562
Patent Literature 2: Japanese Unexamined Patent Application Publication No. 2001-85263
Patent Literature 3: Japanese Unexamined Patent Application Publication No. 2007-242599
Patent Literature 4: Japanese Unexamined Patent Application Publication No. 2010-153485
Patent Literature 5: Japanese Unexamined Patent Application Publication No. 2021-15965

### SUMMARY OF THE INVENTION

### Problems to be Solved by the Invention

Patent Literature 1 describes that, in the multilayer ceramic capacitor described above, the thin metal film layer forms an electrical barrier at the interface with the dielectric layer, so that insulation degradation is less likely to occur.

In the multilayer ceramic capacitor disclosed in Patent Literature 1, however, there is a problem that sufficient capacitance may not be obtained.

As a result of investigating the cause of this, the present inventor has found that, in a multilayer ceramic capacitor with an insufficient capacitance, there are many portions at which an internal electrode is disconnected, as illustrated in (c) in FIG. 5. It is known that, in a multilayer ceramic capacitor, a portion of a dielectric layer adjacent to a portion at which an internal electrode is disconnected does not contribute to capacitance because no voltage is applied thereto during use.

Patent Literatures 3 and 4 each describe that a noble metal contained in a conductive paste for producing an internal electrode can inhibit the grain growth of Ni during firing and prevent the internal electrode from being disconnected. However, the noble metal disclosed in such a literature is present in the conductive paste in a state of being alloyed with Ni and therefore cannot contribute to the formation of an electrical barrier at an interface with a dielectric layer.

Furthermore, Patent Literature 5 describes that Ni and Si contained in a conductive paste for an internal electrode form an internal electrode by forming an alloy, and an excessive amount of Si exceeding an amount necessary for forming the internal electrode is eluted and fills a disconnected portion of the internal electrode. In Patent Literature 5, however, the eluted Si only contributes to inhibition of wet penetration and improvement in chip strength by physically filling a void present in the disconnected portion of the internal electrode and does not inhibit a decrease in capacitance by electrically connecting internal electrodes cut into pieces at the disconnected portion.

Accordingly, it is an object of the present invention to solve the above-described problems and provide a multilayer ceramic capacitor with high insulation reliability and large capacitance.

### Means for Solving the Problems

As a result of various studies to solve the above-described problems, the present inventor has completed the present invention by finding that the above-described object can be achieved by containing a base metal element that forms an alloy with nickel in addition to nickel and a noble metal element in a conductive paste for producing an internal electrode to form a phase with a high base metal element content containing nickel in a portion of the internal electrode with a low noble metal element content in the resulting multilayer ceramic capacitor.

That is, one aspect of the present invention for solving the above-described problems is a multilayer ceramic capacitor including a multilayer chip, which includes a plurality of dielectric layers formed of a dielectric ceramic and internal electrodes disposed on upper and lower surfaces of each of the dielectric layers, a main component element of which internal electrodes is nickel, and which further contain noble metal element(s) and base metal element(s) that form(s) an alloy with nickel, wherein the internal electrodes are alternately extracted and exposed to form a pair of extraction faces facing each other, and external electrodes that electrically interconnect the internal electrodes extracted onto the extraction faces of the multilayer chip, wherein, in the internal electrodes observed on a cross-section perpendicular to the extraction faces, 10 or more segregation sites of the base metal element per layer are present in a region located in a capacitance-forming part in which the internal electrodes adjacent to each other in a lamination direction overlap.

### Effects of the Invention

The present invention can provide a multilayer ceramic capacitor with high insulation reliability and large capacitance.

### BRIEF DESCRIPTION OF THE DRAWINGS

FIG. 1 is a schematic view (a plan view in the length direction) of the structure of a multilayer ceramic capacitor according to one aspect of the present invention.

FIG. 2 is a schematic view (a plan view in the width direction) of the structure of a multilayer ceramic capacitor according to one aspect of the present invention.

FIG. 3 is a schematic view of the structure of an internal electrode in which a segregation site of an alloying base metal element is present in a capacitance-forming part.

FIG. 4 is an explanatory view of a process of forming an internal electrode in a multilayer ceramic capacitor according to one aspect of the present invention.

FIG. 5 is an explanatory view of a process of forming an internal electrode in a multilayer ceramic capacitor according to a related art.

FIG. 6 is a graph of the atomic percentage of each element near an interface with a dielectric layer of an internal electrode in a multilayer ceramic capacitor according to Example 1.

### MODE FOR CARRYING OUT THE INVENTION

The operations and effects of the present invention will be described below together with the technical concepts with reference to the accompanying drawings. However, the mechanism of operations includes presumption, and whether the mechanism of operations is correct or not does not limit the present invention.

### [Multilayer Ceramic Capacitor]

A multilayer ceramic capacitor 100 according to an aspect of the present invention (hereinafter also referred to simply as a “multilayer ceramic capacitor according to the present aspect”) has a rectangular parallelepiped shape and includes a pair of surfaces perpendicular to each of three axes perpendicular to each other, that is, an L axis corresponding to a length direction, a W axis corresponding to a width direction, and a T axis corresponding to a height direction. The rectangular parallelepiped is not limited to a rectangular parallelepiped defined mathematically and may be any shape that is recognized as a rectangular parallelepiped when the entire shape is observed. Thus, the rectangular parallelepiped in the present disclosure also includes a rectangular parallelepiped with a rounded ridge part or corner part, a rectangular parallelepiped with a curved ridge part, and a rectangular parallelepiped shape whose constituent faces are curved faces having a small curvature. The dimension in the length (L) direction, the dimension in the width (W) direction, and the dimension in the height (T) direction of the ceramic capacitor 100 can each independently take any value, and the magnitude relationship thereof is also not limited. For example, (the dimension in the L direction)>(the dimension in the W direction)≥(the dimension in the T direction) may be satisfied, (the dimension in the W direction)>(the dimension in the L direction) may be satisfied, or (the dimension in the T direction)>(the dimension in the W direction) may be satisfied.

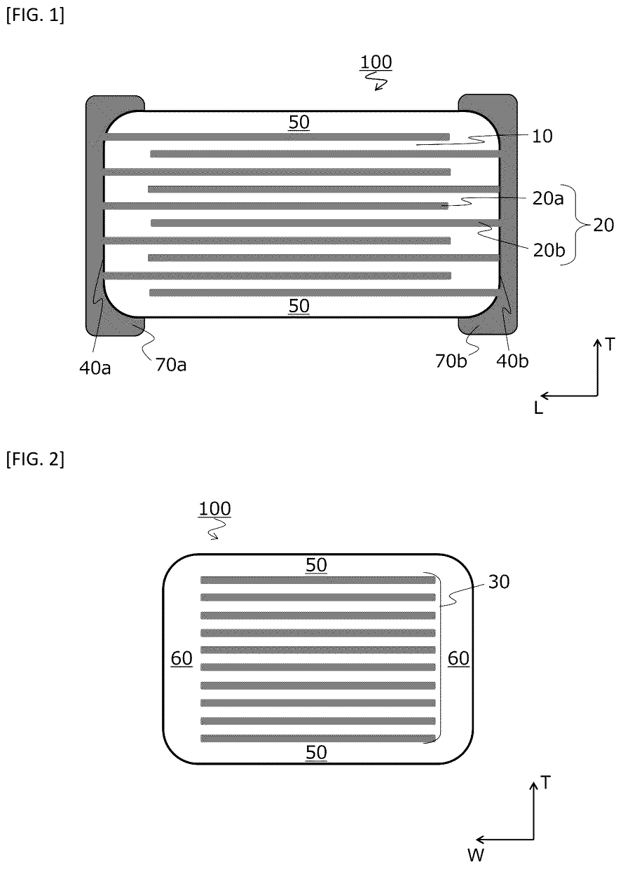

As its cross-sectional views are schematically illustrated in FIG. 1 (an LT cross-section) and FIG. 2 (a WT cross-section), the multilayer ceramic capacitor 100 according to the present aspect includes a multilayer chip 30 that includes a plurality of dielectric layers 10 formed of a dielectric ceramic and internal electrodes 20 disposed on upper and lower surfaces perpendicular to the lamination direction (T direction) of the dielectric layers 10. The multilayer chip 30 includes an extraction face 40a on which internal electrodes 20a are extracted and exposed in the length direction (L direction) and an extraction face 40b on which internal electrodes 20b are extracted and exposed in the length direction (L direction). That is, the internal electrodes 20 are alternately extracted and exposed on the extraction faces 40a and 40b. The multilayer chip 30 may have cover portions 50 formed on the upper and lower surfaces in the lamination direction. Also, the multilayer chip 30 may have side margin portions 60 formed on side surfaces perpendicular to the extraction faces 40a and 40b and the upper and lower surfaces. The multilayer ceramic capacitor 100 according to the present aspect includes external electrodes 70a and 70b that electrically interconnect the extracted internal electrodes 20a and 20b on the extraction faces 40a and 40b, respectively. It should be noted that the multilayer ceramic capacitor 100 according to the present aspect may include terminal electrodes (not shown) electrically connected to the external electrodes 70a and 70b and electrically connected to an external circuit when mounted on a circuit board.

Portions constituting the multilayer ceramic capacitor 100 according to the present aspect will be described below in detail.

### (Dielectric Layer)

The dielectric layers 10 are formed of a dielectric ceramic. The compositional makeup of the dielectric ceramic is not particularly limited and may be appropriately selected according to the properties required for the multilayer ceramic capacitor 100. A preferred compositional makeup of the dielectric ceramic is, for example, a composition containing barium titanate (BaTiO₃) as a main component. The dielectric layers 10 may contain the following additive element. The additive element is, for example, at least one type selected from Mo, Nb, Ta, W, Mg, Mn, V, Cr, rare-earth elements (Y, Sm, Eu, Gd, Tb, Dy, Ho, Er, Tm, and Yb), Co, Ni, Li, B, Na, K, and Si. The additive element may be contained as an element or may be contained in the form of a compound, such as an oxide, a nitride, or a carbide. Furthermore, the additive element may be present in a state of solid solution in the main component barium titanate or may form a heterophase with an element constituting the main component or with another additive element.

### (Internal Electrode)

The internal electrodes 20 contain nickel (Ni) as a main component element. The term “main component element”, as used herein, refers to an element with the highest content expressed in atomic percentage (atom %). Since the internal electrodes 20 contain nickel as a main component element, the amount of expensive material to be used, such as a noble metal, can be reduced, and the production costs of the multilayer ceramic capacitor 100 can be reduced.

The internal electrodes 20 contain a noble metal element in addition to the main component element nickel. The term “noble metal element”, as used herein, refers to silver (Ag) or a metal with a higher standard electrode potential than silver. There are eight metal elements that meet this definition: gold (Au), silver (Ag), platinum (Pt), palladium (Pd), rhodium (Rh), iridium (Ir), ruthenium (Ru), and osmium (Os).

Since the internal electrodes 20 contain a noble metal element, the multilayer ceramic capacitor 100 has high insulation reliability. This is probably because an electrical barrier is formed at the interfaces with the dielectric layers 10 by the operation of the noble metal element and improves the electrical insulating property between adjacent internal electrodes 20a and 20b. From the perspective that the operation of the noble metal element becomes remarkable, the internal electrodes 20 preferably have a region with an atomic percentage of the noble metal element higher than that of the central portion in the thickness direction (a noble metal element concentrated region) near the interfaces with the dielectric layers 10.

Here, it is confirmed by the following procedure that the internal electrodes 20 have a region with an atomic percentage of the noble metal element higher than that of the central portion in the thickness direction near the interfaces with the dielectric layers 10. First, from the vicinity of the central portion of the multilayer ceramic capacitor 100 in the width direction (W direction), that is, from a position between ⅓ and ⅔ of the dimension in the W direction, a thin sample with a thickness in the range of 50 nm to 100 nm and with a surface parallel to the lamination direction (T direction) as a principle face is taken out using a focused ion beam device (FIB). The vicinity of the central portion of the thin sample, that is, a position between ⅓ and ⅔ of each dimension in the T direction and the L direction, is then observed with a scanning transmission electron microscope (STEM) equipped with an energy-dispersive X-ray spectroscopy (EDS) detector to determine a visual field in which both the dielectric layers 10 and the internal electrodes 20 can be observed. It should be noted that in a STEM image, a difference between the dielectric layers 10 and the internal electrodes 20 is recognized by a difference in contrast (light and darkness), and the dielectric layers 10 are observed to be dark (blackish) and the internal electrodes 20 are observed to be light (whitish). Line analysis is then performed by EDS near interfaces between the dielectric layers 10 and the internal electrodes 20 to measure the characteristic X-ray intensities of the noble metal element, titanium, and nickel at each measurement point. In the measurement, the accelerating voltage is 200 kV, the electron-beam size is 1.0 nm, and the measurement time per measurement point is 20 minutes. Also, the measurement is repeated five or more times for one measurement point, and the average value of the obtained specific X-ray intensities of the respective elements is defined as the characteristic X-ray intensity of the respective elements at the measurement point. The line analysis is performed in the direction perpendicular to the interfaces from the dielectric layers 10 side toward the internal electrodes 20 side. For each measurement point, correction (ZAF correction) in consideration of the atomic number effect, the absorption effect, and the fluorescence excitation effect is then performed from the obtained characteristic X-ray intensity of each element to calculate the atomic percentages of the noble metal element, titanium, and nickel at each measurement point, and the atomic percentages are plotted with respect to the measurement position to construct a graph. Next, based on the fact that the maximum value of the atomic percentage of the noble metal element in a region within 2 nm on the internal electrodes 20 side from the position of the intersection point of the graph of the atomic percentage of Ni and the graph of the atomic percentage of Ti is higher than the average value of the atomic percentage of the noble metal element in a region (inner region) farther from the dielectric layers 10 than the region, it is determined that the internal electrodes 20 have a region with a higher mass ratio of the noble metal element than the central portion in the thickness direction near the interfaces with the dielectric layers 10. It should be noted that the average value of the atomic percentage of the noble metal element in the inner region is calculated by dividing the sum of the atomic percentages of the noble metal element (percentage points) at the measurement points located in the inner region by the number of the measurement points located in the inner region.

The noble metal element content of the internal electrodes 20 is preferably, but not limited to, 0.01 atomic percent or more and 5.0 atomic percent or less, more preferably 0.03 atomic percent or more and 4.0 atomic percent or less, still more preferably 0.05 atomic percent or more and 3.0 atomic percent or less, in total with respect to nickel. When the total amount of the noble metal element with respect to nickel is 0.01 atomic percent or more, the multilayer ceramic capacitor 100 has significantly improved insulation reliability. On the other hand, when the total amount of the noble metal element with respect to nickel is 5.0 atomic percent or less, the production costs of the multilayer ceramic capacitor 100 can be reduced.

The internal electrodes 20 contain a base metal element that forms an alloy with nickel (hereinafter also referred to as an “alloying base metal element” in the present description) in addition to the main component element nickel and the noble metal element. The term “element that forms an alloy with nickel”, as used herein, refers to an element that forms a solid solution or an intermetallic compound in a binary equilibrium phase diagram with nickel. Also, the term “base metal element”, as used herein, refers to a metal element other than the above-described noble metal element. It should be noted that the main component element nickel in the internal electrodes 20 also corresponds to the base metal element in the present disclosure. However, regarding the base metal element in the present application, in the case where nickel is distinguished from the base metal element in the context and is described in parallel with the base metal element, the base metal element refers to a base metal element excluding nickel.

The type of the alloying base metal element is preferably, but not limited to, at least one type selected from iron (Fe), aluminum (Al), zinc (Zn), chromium (Cr), copper (Cu), tin (Sn), titanium (Ti), germanium (Ge), indium (In), and magnesium (Mg) from the perspective of effectively inhibiting the disconnection of the internal electrodes 20. These base metal elements are preferable in that they easily form an alloy with nickel.

The alloying base metal element content of the internal electrodes 20 is preferably, but not limited to, 0.03 atomic percent or more and 3.0 atomic percent or less, more preferably 0.05 atomic percent or more and 2.5 atomic percent or less, still more preferably 0.1 atomic percent or more and 2.0 atomic percent or less, in total with respect to nickel. When the total amount of the alloying base metal element with respect to nickel is 0.03 atomic percent or more, the multilayer ceramic capacitor 100 has a significantly increased capacitance. On the other hand, when the total amount of the alloying base metal element with respect to nickel is 3.0 atomic percent or less, it is possible to inhibit deterioration of the properties of the multilayer ceramic capacitor 100 due to the diffusion of the base metal element into the dielectric layers.

Here, the total amount of the noble metal element and the total amount of the alloying base metal element in the internal electrodes 20 are determined by the following procedure. First, the multilayer ceramic capacitor 100 is processed by cutting, polishing, or the like to expose a cross-section that is perpendicular to the extraction faces 40a and 40b and in which the internal electrodes 20 are to be observed. This cross-section is a cross-section near the central portion in the width direction (W direction) of the multilayer ceramic capacitor 100 (a cross-section between ⅓ and ⅔ of the dimension in the width direction). Carbon is then vapor-deposited on the exposed cross-section to prepare a measurement specimen. The vicinity of the center of the cross-section of the measurement specimen is then observed with a scanning electron microscope (SEM) equipped with an energy-dispersive X-ray spectrometer (EDS) or a wavelength dispersive X-ray spectrometer (WDS), or an electron probe microanalyzer (EPMA) at a magnification at which three or more and six or less internal electrodes 20 adjacent to each other in the lamination direction are observed in the visual field, and three consecutive internal electrodes 20 adjacent to each other in the lamination direction in the visual field are selected as measurement objects. The internal electrodes 20 to be measured are then subjected to line analysis in which the vicinity of the central portion in the thickness direction (T direction) is scanned over the entire length (L direction) in the visual field, and the nickel content, the total amount of the noble metal element, and the total amount of the alloying base metal element at each measurement point are each calculated in atomic percentage. For each measurement point, the atomic percentage of the noble metal element with respect to nickel and the atomic percentage of the alloying base metal element with respect to nickel are then calculated from the obtained atomic percentages of the respective elements. Finally, a value obtained by dividing the sum of the atomic percentage of the noble metal element with respect to nickel obtained for each measurement point by the number of measurement points is defined as the noble metal element content of the internal electrodes 20. Furthermore, a value obtained by dividing the sum of the atomic percentage of the alloying base metal element with respect to nickel obtained for each measurement point by the number of measurement points is defined as the alloying base metal element content of the internal electrodes 20.

It should be noted that when a paste for an internal electrode used for production has a known metal compositional makeup, the above-described procedure may be omitted, and the total amount of the noble metal element and the total amount of the alloying base metal element in the internal electrodes 20 may be calculated based on the known compositional makeup.

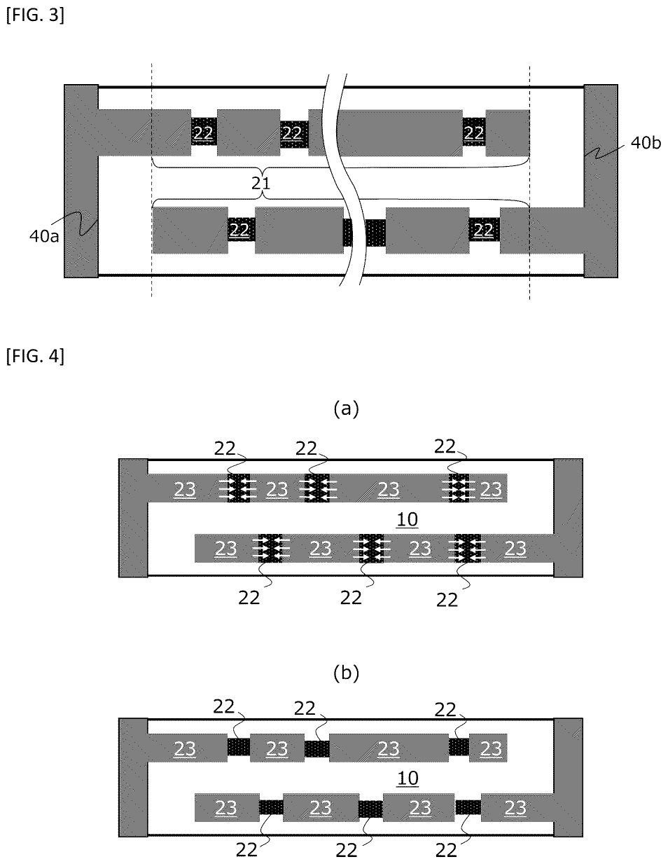

In addition to containing the alloying base metal element, as illustrated in FIG. 3, the internal electrodes 20 have ten or more segregation sites 22 of the alloying base metal element per layer in a region 21 located in a capacitance-forming part in which the internal electrodes adjacent to each other in the lamination direction overlap, as observed in a cross-section perpendicular to the extraction faces 40a and 40b. With these features, the internal electrodes 20 have a reduced number of disconnected portions, and the multilayer ceramic capacitor 100 has a large capacitance. This is presumed to be due to the following mechanism of operation.

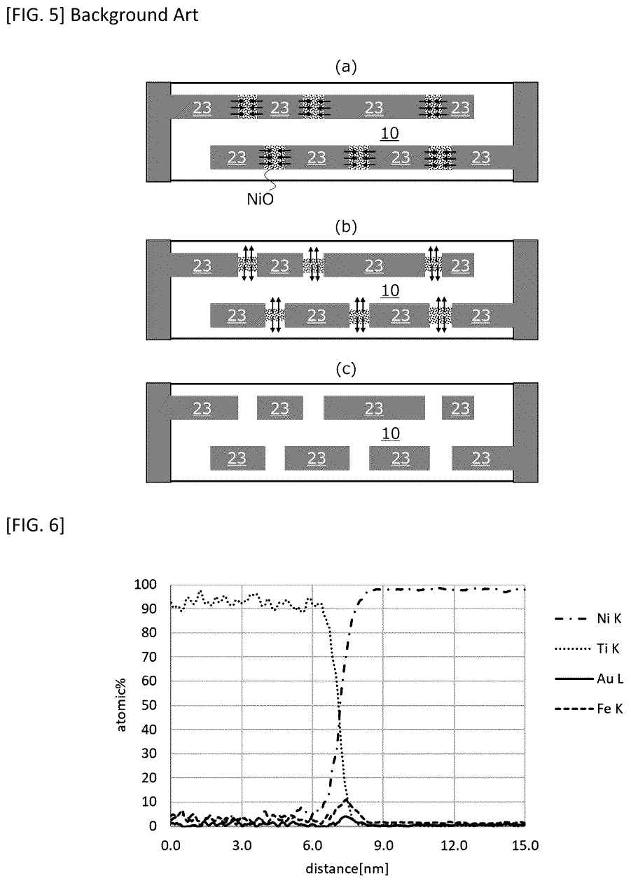

To produce the multilayer ceramic capacitor 100, firing is performed for the purpose of forming the dielectric layers 10 and the internal electrodes 20 by sintering, as described later. If necessary, a heat treatment may be performed for the purpose of reoxidation of the dielectric ceramic forming the dielectric layers 10. In the multilayer ceramic capacitor 100 in which the internal electrodes 20 contain nickel as a main component element and only a noble metal element as another metal component, during such firing or heat treatment, nickel oxide produced by oxidation of nickel is discharged from an alloy portion 23 of the nickel and the noble metal element and is concentrated at a specific location in the internal electrodes 20, as illustrated in (a) of FIG. 5. Nickel oxide has high reactivity with the dielectric ceramic forming the dielectric layers 10 and therefore diffuses into the dielectric layers 10, as illustrated in (b) of FIG. 5. As a result, as illustrated in (c) of FIG. 5, the internal electrodes 20 are disconnected at portions where the nickel oxide is present. In contrast, in the multilayer ceramic capacitor 100 in which the internal electrodes 20 contain nickel as a main component element and contains an alloying base metal element in addition to a noble metal element, as illustrated in (a) of FIG. 4, nickel forms an alloy with the alloying base metal element before being oxidized, is phase-separated from the alloy portion 23 of the nickel and the noble metal element in a metal state, and forms the segregation sites 22 of the alloying base metal element. Since the segregation sites 22 of the alloying base metal element are not completely oxidized even after the firing and the heat treatment and the metal portion remains, the number of portions where the internal electrodes 20 are disconnected is reduced, as illustrated in (b) of FIG. 4. At this time, in the segregation sites 22 of the alloying base metal element, the atomic percentage of the noble metal element is lower than that in the alloy portion 23 of the nickel and the noble metal. In this case, when the internal electrodes 20 have the above-described noble metal element concentrated region near the interfaces with the dielectric layers 10, the magnitude relationship of the atomic percentage of the noble metal element in the internal electrodes 20 is (the noble metal element concentrated region)>(the central portion in the thickness direction of the portion other than the segregation sites of the base metal element)>(the segregation sites of the alloying base metal element).

Here, the number of the segregation sites 22 of the alloying base metal element in the internal electrodes 20 is determined by one of the following two procedures.

In the first procedure, first, a measurement specimen is prepared by the same procedure as that in determining the total amount of each of the noble metal element and the alloying base metal element in the internal electrodes 20 described above and is observed by SEM or EPMA at a magnification at which two or more and six or less internal electrodes 20 adjacent to each other in the lamination direction (T direction) are observed in the visual field. This magnification typically ranges from 3000 times to 20000 times. The region observed by SEM or EPMA is then subjected to map analysis of nickel, the noble metal element, and the alloying base metal element. Next, in the obtained results, a region of the internal electrodes 20 in which the atomic percentage of the noble metal element is ½ or less of the atomic percentage in the entire internal electrodes 20 is focused on, and when the atomic percentage of the alloying base metal element is higher in the region than in a region adjacent in the length direction (L direction) in the internal electrodes 20, the region is selected as a candidate for the segregation sites 22 of the alloying base metal element. Among the candidates for the segregation sites 22 of the alloying base metal element, a region in which the dimension in the length direction (L direction) of the internal electrodes 20 is ½ or more of the average thickness of the internal electrodes 20, that is, the average dimension in the height direction (T direction), is then counted as the actual segregation sites 22 of the alloying base metal element.

Also in the second procedure, first, a measurement specimen is prepared by the same procedure as that in determining the total amount of each of the noble metal element and the alloying base metal element in the internal electrodes 20 described above and is observed by SEM or EPMA at a magnification at which two or more and six or less internal electrodes 20 adjacent to each other in the lamination direction are observed in the visual field. This magnification typically ranges from 3000 times to 20000 times. Any one of the internal electrodes 20 located in the central portion in the lamination direction (T direction) is then selected as a measurement object, and line analysis is performed on the region 21 located in the capacitance-forming part of the internal electrodes 20 by the same procedure as that in determining the total amount of each of the noble metal element and the alloying base metal element in the internal electrodes 20 described above, and the nickel content and the total amount of the alloying base metal element at each measurement point are calculated in atomic percentage. For each measurement point, the atomic percentage of the alloying base metal element with respect to nickel is then calculated from the obtained atomic percentages of the respective elements. Next, a portion where measurement points at which the atomic percentage is higher than the alloying base metal element content of the entire internal electrodes 20 are continuously observed over a length of ½ or more of the average thickness of the internal electrodes 20, that is, the average dimension in the height direction (T direction), is defined as a segregation site 22 of the alloying base metal element, and a region where the measurement points are continuous is defined as one segregation site.

In both the first procedure and the second procedure, the measurement is repeated while moving the observation visual field in the length direction (L direction) of one internal electrode 20. The number of the segregation sites 22 of the alloying base metal element in each visual field thus obtained is summed up for the entire region 21 located in the capacitance-forming part of one internal electrode 20, and the average value of three internal electrodes 20 is defined as the number of the segregation sites 22 of the alloying base metal element per internal electrode 20 in one layer of this sample.

In principle, the above-described map analysis and line analysis are performed on the entire region 21 located in the capacitance-forming part of the three internal electrodes 20. As illustrated in (b) of FIG. 4, however, since the internal electrodes 20 often have a small thickness (a small dimension in the T direction) at the segregation sites 22 of the alloying base metal element, it is also possible to specify a portion where the internal electrodes 20 have a small width in a SEM image or an EPMA image and to perform the map analysis or the line analysis only near the portion for the purpose of shortening the measurement time.

The ratio of the sum of the dimensions in the length direction (L direction) of the segregation sites 22 of the alloying base metal element to the dimension in the length direction (L direction) of the region 21 located in the capacitance-forming part of the internal electrodes 20 is preferably less than ½, more preferably ⅓ or less, still more preferably ¼ or less. A low ratio results in the internal electrodes 20 with low electrical resistance and the multilayer ceramic capacitor 100 with a low loss.

The internal electrodes 20 may have, near the interfaces with the dielectric layers 10, a region (base metal element concentrated region) with an atomic percentage of the alloying base metal element higher than that of the central portion in the thickness direction. Containing a large amount of alloying base metal element near the interfaces with the dielectric layers 10, the multilayer ceramic capacitor 100 can have higher insulation reliability and a larger capacitance. In this case, the magnitude relationship of the atomic percentage of the base metal element in the internal electrodes 20 is (the segregation sites of the base metal element)>(the base metal element concentrated region)>(the central portion in the thickness direction of the portion other than the segregation sites of the base metal element).

Here, the fact that the internal electrodes 20 have the region in which the atomic percentage of the alloying base metal element is higher than that of the central portion in the thickness direction near the interfaces with the dielectric layers 10 is confirmed by the same procedure as in the case of the noble metal element described above.

The thickness of the internal electrodes 20, that is, the dimension in the lamination direction (T direction), is preferably, but not limited to, 0.8 μm or less, more preferably 0.6 μm or less, still more preferably 0.4 μm or less, from the perspective of increasing the number of laminated layers in the multilayer chip 30 with a constant dimension in the lamination direction and producing the multilayer ceramic capacitor 100 with a larger capacitance. The multilayer ceramic capacitor 100 including such thin internal electrodes 20 has a more significant effect of inhibiting a decrease in capacitance by the above-described measures for inhibiting the disconnection of the internal electrodes 20.

### (External Electrodes)

The external electrodes 70a and 70b are provided on the extraction faces 40a and 40b of the multilayer chip 30 and electrically interconnect the internal electrodes 20a and the internal electrodes 20b that are extracted to the respective surfaces. Although the external electrodes 70a and 70b illustrated in FIG. 1 extend from the extraction faces 40a and 40b of the multilayer chip 30 to the upper and lower surfaces and the side surfaces, the shapes of the external electrodes 70a and 70b are not limited thereto.

Materials of the external electrodes 70a and 70b are not limited as long as they have conductivity. The materials are, for example, metals, such as copper (Cu), nickel (Ni), tin (Sn), palladium (Pd), platinum (Pt), silver (Ag), and gold (Au), and alloys containing any of these metals as a main component element.

### (Cover Portion and Side Margin Portion)

The cover portions 50 and the side margin portions 60 function as protective parts that protect the dielectric layers 10 and the internal electrodes 20.

Materials of the cover portions 50 and the side margin portions 60 are not limited as long as they have high electrical insulating property and low permeability to a degradation factor, such as water. The cover portions 50 and the side margin portions 60 are preferably made of the same material as the dielectric ceramic forming the dielectric layers 10 to achieve uniform shrinkage during firing in the production of the multilayer ceramic capacitor 100, to relieve internal stress in the multilayer ceramic capacitor 100, or the like.

### [Method for Producing Multilayer Ceramic Capacitor]

The multilayer ceramic capacitor according to the present aspect is produced, for example, by preparing a green sheet containing a powder of a dielectric ceramic composition and a binder, preparing a paste for an internal electrode containing a metal powder containing nickel, a noble metal element, and an alloying base metal element, and a vehicle, printing the paste for an internal electrode on the green sheet, stacking a predetermined number of the green sheets on which the paste for an internal electrode is printed, pressure-bonding the green sheets to form a formed green sheet, removing the binder from the formed green sheet, applying a conductive paste to an extraction face of a precursor of a multilayer chip to form external electrodes, and producing the multilayer chip by firing. The external electrodes can also be formed by applying the conductive paste to the extraction face of the fired multilayer chip and then baking the paste. Each operation will be described in detail below.

### (Preparation of Dielectric Ceramic Composition Powder)

The powder of the dielectric ceramic composition is prepared, for example, by mixing various raw material powders containing constituent elements thereof at a predetermined ratio and pre-firing (calcining) the mixture. When the various raw material powders are mixed at the predetermined ratio, various additives, such as the above-described additive element and a sintering auxiliary agent, may be further added, or these various additives may be further added to the powder after calcining.

The raw material powders may be mixed by any method that can uniformly mix the powders while inhibiting contamination with impurities and may be mixed by dry mixing or wet mixing. In a case where wet mixing using a ball mill is adopted as a mixing method, for example, partially stabilized zirconia (PSZ) balls may be used, and after stirring for approximately 8 hours to 60 hours with the ball mill using an organic solvent, such as ethanol, or water as a dispersion medium, the dispersion medium may be evaporated.

The conditions for calcining of the raw material mixed powder are not particularly limited as long as the above-described various raw material powders are reacted to produce a predetermined dielectric ceramic composition. For example, firing is performed in the air at a temperature in a range of 800° C. to 1100° C. for 1 hour to 10 hours. The powder after the calcining may be processed into a green sheet as it is but is preferably pulverized with a ball mill, a stamp mill, or the like, from the perspective of preparing a smooth green sheet through a homogeneous slurry and from the perspective of improving sintering property.

It should be noted that when a commercial product can be used as the dielectric ceramic composition powder, the subsequent operations may be performed on this powder without performing the above-described mixing and calcining of the raw material powders.

### (Preparation of Green Sheet)

The green sheet containing the powder of the dielectric ceramic composition and the binder is prepared, for example, by mixing the powder of the dielectric ceramic composition with the binder and a dispersion medium to prepare a slurry and forming the slurry into a sheet shape.

The binder may be a binder that can maintain the shape of the green sheet described later and volatilize without leaving carbon or the like by firing or binder removal treatment before firing. The binder that can be used is, for example, a poly(vinyl alcohol)-based, poly(vinyl butyral)-based, cellulose-based, urethane-based, or vinyl acetate-based binder. The amount of the binder to be used is also not particularly limited, but since the binder is removed in a subsequent step, from the perspective of reducing the raw material cost, it is preferable to reduce the amount of the binder as much as possible within a range in which desired compactibility and shape retainability are achieved.

The dispersion medium is a dispersion medium that does not cause aggregation of the powder after the calcining or the binder and can be easily removed by volatilization or the like after forming a green sheet described later. The dispersion medium that can be used is, for example, water, an alcohol-based solvent, or the like.

A component for adjusting the properties of the slurry, such as a dispersant, a plasticizer, or a thickening agent, may be added to the slurry.

The mixed powder may be mixed with the binder and the dispersion medium by any method that can uniformly mix the components while preventing contamination with impurities. One example is ball mill mixing.

A method of forming the prepared slurry into a sheet shape to form a green sheet may be a commonly used method, such as a doctor blade method.

### (Preparation of Paste for Internal Electrode)

The paste for an internal electrode containing the metal powder, which contains nickel, the noble metal element, and the alloying base metal element, and the vehicle is prepared, for example, by mixing the metal powder containing the metal elements and the vehicle using a three-roll mill. The paste for an internal electrode may contain a glass frit or a dielectric ceramic composition powder in addition to the above-described components.

The type of the metal powder to be used is, for example, but not limited to, a powder consisting essentially of each metal element. For the purpose of inhibiting oxidation of the metal particle surface in the case of using a nickel powder and an alloying base metal powder, an alloy powder of nickel and an alloying base metal element may be used.

The types and amounts of the binder and solvent contained in the vehicle to be used are also not limited and may be appropriately selected in consideration of the viscosity, handleability, compatibility with the green sheet, and the like of the paste for an internal electrode.

### (Printing of Paste for Internal Electrode)

The paste for an internal electrode can be printed on the green sheet, for example, using a screen mask with a predetermined internal electrode pattern. At the time of printing, printing may be performed with a space to be a side margin portion when a multilayer ceramic capacitor is produced.

### (Preparation of Formed Green Sheet)

The formed green sheet is formed, for example, by stacking a predetermined number of green sheets on which an internal electrode precursor is disposed and pressure-bonding the green sheets. The stacking and pressure-bonding may be performed by a commonly used method, such as a method of heating and pressing the stacked green sheets in the lamination direction for thermocompression bonding by the operation of the binder.

At the time of stacking and pressure-bonding, a green sheet to be a cover portion when a multilayer ceramic capacitor is produced may be added to both end portions in the lamination direction. In this case, the green sheet to be added may have the same compositional makeup as that of the green sheet with the internal electrode pattern printed or may have a different compositional makeup from that of the green sheet. From the perspective of making shrinkage rates at the time of firing uniform, the compositional makeup of the green sheet to be added is preferably the same as or similar to the compositional makeup of the green sheets on which the internal electrode precursor is disposed.

### (Production of Multilayer Chip)

The multilayer chip is produced by firing the above-described formed green sheet. The binder may be removed from the formed green sheet before firing. In this case, the removal of the binder and the firing may be continuously performed with the same firing apparatus. The conditions for the removal of the binder and the firing may be appropriately determined in consideration of the volatilization temperature of the binder, the binder content, the sintering property of the dielectric ceramic composition, the heat resistance and oxidation resistance of the metal contained in the paste for an internal electrode, and the like. Examples of conditions for the removal of the binder include a temperature in the range of 200° C. to 500° C. and a time in the range of 5 hours to 20 hours in a nitrogen (N₂) atmosphere. When the external electrodes are formed before firing, the external electrodes are formed at this stage, as described later. Furthermore, examples of the firing conditions include holding in a mixed reducing atmosphere of nitrogen (N₂), hydrogen (H₂), and water vapor (H₂O) at 800° C. to 1000° C. for 10 minutes to 1 hour and then firing at 1000° C. to 1400° C. for 10 minutes to 2 hours. Holding the temperature during firing can provide a multilayer ceramic capacitor with a large capacitance. This is probably because holding the temperature promotes the discharge of the alloy of nickel and the alloying base metal element from the alloy region of nickel and the noble metal element and inhibits the deterioration of the continuity of the internal electrodes due to the oxidation of nickel during firing and the diffusion of nickel oxide into the dielectric layer. Furthermore, the temperature holding during the firing is also effective as a means for increasing the concentration of the base metal element in the segregation site of the alloying base metal element to be higher than that of the base metal element concentrated region described above. The firing is preferably performed at a temperature higher by 50° C. or more than the calcining temperature in terms of the strength of the multilayer chip produced by sintering. The firing may be followed by a reoxidation treatment of holding at 600° C. to 1000° C. in a nitrogen (N₂) gas atmosphere or a low-oxygen atmosphere. When a plurality of multilayer chips are produced from one formed green sheet, the formed green sheet may be divided into several blocks before or after firing.

### (Formation of External Electrodes)

When the external electrodes are formed before firing, the binder is removed from the formed green sheet, and a conductive paste is then applied to the extraction faces of the precursor of the multilayer chip. A method for applying the conductive paste may be printing, dipping, or the like. The precursor of the multilayer chip is then fired to produce the multilayer chip, and at the same time the conductive paste can be sintered to form the external electrodes.

When the external electrodes are formed after firing, the conductive paste is applied to the extraction faces of the fired multilayer chip and is then baked to form the external electrodes, thereby producing a multilayer ceramic capacitor. A method for applying the conductive paste may be printing, dipping, or the like.
The external electrodes may have a nickel plating layer or a tin plating layer as an outer layer.

### EXAMPLES

Although the present invention is more specifically described in the following examples, the present invention is not limited to these examples.

### Example 1

### (Preparation of Paste for Internal Electrode)

A nickel-iron alloy powder containing 1.0 atomic percent of iron with respect to nickel, 1.0 atomic percent of a gold powder with respect to nickel in the alloy powder, and a vehicle were mixed using a three-roll mill to prepare a paste for an internal electrode.

### (Production of Multilayer Ceramic Capacitor)

As a powder of a dielectric ceramic composition, a barium titanate (BaTiO₃) powder subjected to calcining was prepared as a main raw material, and powders of oxides of Mn, Ho, and Si were prepared as minor additive components. A poly(vinyl butyral)-based binder and an alcohol-based solvent were added to these powders and were mixed using a wet ball mill. The mixed slurry thus prepared was formed into a green sheet using a doctor blade. The paste for an internal electrode described above was screen-printed on the green sheet to form an electrode pattern, 500 of the green sheets were stacked, 20 of the green sheets to be cover portions on which the paste for an internal electrode was not printed were stacked on each of the upper and lower surfaces of the stacked green sheets, and the stacked green sheets were pressure-bonded at a pressure of approximately 190 MPa while heating to form a laminated body. The laminated body was separated into individual pieces and was heated to 300° C. in a nitrogen atmosphere to perform a binder removal process. The extraction faces of the multilayer chip were immersed in a conductive paste containing nickel to form a precursor of an external electrode. The laminated body after the formation of the precursor of the external electrode was held at 800° C. for 30 minutes in a so-called reducing steam atmosphere in which steam was introduced into a reducing gas containing hydrogen in nitrogen, was then fired at 1200° C. for 2 hours, was then held at 700° C. for 1 hour in a nitrogen atmosphere in the middle of temperature decrease, and was then cooled to approximately room temperature to produce a multilayer ceramic capacitor according to Example 1. In the multilayer ceramic capacitor, a surface perpendicular to the lamination direction of the multilayer chip had a rectangular shape of 1.0 mm×0.5 mm, and each dielectric layer had a thickness of 0.6 μm.

### Example 2

A multilayer ceramic capacitor according to Example 2 was produced in the same manner as in Example 1 except that the nickel-iron alloy powder in the paste for an internal electrode contained 0.1 atomic percent of iron with respect to nickel.

### Example 3

A multilayer ceramic capacitor according to Example 3 was produced in the same manner as in Example 1 except that the gold powder content of the paste for an internal electrode was 0.1 atomic percent with respect to nickel in the nickel-iron alloy powder.

### Example 4

A multilayer ceramic capacitor according to Example 4 was produced in the same manner as in Example 1 except that the nickel-iron alloy powder in the paste for an internal electrode was changed to a nickel-chromium alloy powder containing 1.0 atomic percent of chromium with respect to nickel.

### Example 5

A multilayer ceramic capacitor according to Example 5 was produced in the same manner as in Example 1 except that the nickel-iron alloy powder in the paste for an internal electrode was changed to a nickel-zinc alloy powder containing 1.0 atomic percent of zinc with respect to nickel.

### Example 6

A multilayer ceramic capacitor according to Example 6 was produced in the same manner as in Example 1 except that the nickel-iron alloy powder in the paste for an internal electrode was changed to a nickel-aluminum alloy powder containing 1.0 atomic percent of aluminum with respect to nickel.

### Example 7

A multilayer ceramic capacitor according to Example 7 was produced in the same manner as in Example 1 except that the gold powder in the paste for an internal electrode was changed to 1.0 atomic percent of a silver powder with respect to nickel in the nickel-iron alloy powder.

### Comparative Example 1

A multilayer ceramic capacitor according to Comparative Example 1 was produced in the same manner as in Example 1 except that the nickel-iron alloy powder in the paste for an internal electrode was changed to a nickel powder, and the gold powder was not mixed at the time of preparing the paste for an internal electrode.

### Comparative Example 2

A multilayer ceramic capacitor according to Comparative Example 2 was produced in the same manner as in Example 1 except that the gold powder was not mixed at the time of preparing the paste for an internal electrode.

### Comparative Example 3

A multilayer ceramic capacitor according to Comparative Example 3 was produced in the same manner as in Example 1 except that the nickel-iron alloy powder in the paste for an internal electrode was changed to a nickel powder.

### Comparative Example 4

A multilayer ceramic capacitor according to Comparative Example 4 was produced in the same manner as in Example 1 except that the nickel-iron alloy powder in the paste for an internal electrode contained 0.01 atomic percent of iron with respect to nickel.

### Comparative Example 5

A multilayer ceramic capacitor according to Comparative Example 5 was produced in the same manner as in Comparative Example 3 except that a silver powder was further mixed in the preparation of the paste for an internal electrode.

### Comparative Example 6

A multilayer ceramic capacitor according to Comparative Example 6 was produced in the same manner as in Comparative Example 2 except that the nickel-iron alloy powder in the paste for an internal electrode was changed to a nickel-iron-aluminum alloy powder containing 1.0 atomic percent of iron and 1.0 atomic percent of aluminum with respect to nickel.

### [Evaluation of Multilayer Ceramic Capacitor]

### (Segregation Site of Alloying Base Metal Element)

For each of the multilayer ceramic capacitors thus produced, the number of segregation sites of the alloying base metal element in the internal electrodes was determined by the method described above.

### (Capacitance)

For each of the multilayer ceramic capacitors thus produced, the impedance was measured at a temperature of 25° C. and at a voltage of 0.5 Vᵣₘₛ applied at a frequency of 1 kHz, and the capacitance was calculated from the measurement results.

### (Reliability)

A DC electric field of 10 V/μm was applied to the multilayer ceramic capacitors thus produced (n=50) at 85° C. for 1000 hours, the multilayer ceramic capacitors were then allowed to stand at room temperature for 24 hours, and production of at least one multilayer ceramic capacitor with an insulation resistance of less than 10 MΩ was regarded as a failure. A multilayer ceramic capacitor with no failure was evaluated as good (O), and a multilayer ceramic capacitor with a failure was evaluated as poor (x).

(Presence or Absence of Region with High Atomic Percentages of Noble Metal Element and Alloying Base Metal Element in Internal Electrode)

In the multilayer ceramic capacitor according to Example 1, it was confirmed by the above-described method whether or not the internal electrodes had a region in which the atomic percentages of the noble metal element and the alloying base metal element were higher than those in the central portion in the thickness direction near the interfaces with the dielectric layers. As a result, a graph of atomic percentages illustrated in FIG. 6 was obtained, and it was confirmed that the multilayer ceramic capacitor according to Example 1 had a region in which the atomic percentages of both the noble metal element and the alloying base metal element were higher than those in the central portion in the thickness direction at the interfaces between the internal electrodes and the dielectric layers.

Table 1 summarizes the compositional makeup of the internal electrodes, the number of segregation sites of the alloying base metal element per internal electrode layer, the capacitance, and the evaluation results of the reliability of the multilayer ceramic capacitors produced in the examples and the comparative examples. The capacitance is a relative value when the value of Comparative Example 1 is 100.

TABLE 1

| | | | | | Number of | | |
|---|---|---|---|---|---|---|---|
| | | | | | segregation sites | | |
| | | | Base metal element | | of base metal | | |
| | Noble metal element | | to be alloyed with Ni | | element to be | | |
| | Type | Amount*¹ | Type | Amount*¹ | alloyed with Ni | Capacitance*² | Reliability |
| Example 1 | Au | 1.0 | Fe | 1.0 | 85 | 100 | ∘ |
| Example 2 | Au | 1.0 | Fe | 0.1 | 11 | 91 | ∘ |
| Example 3 | Au | 0.1 | Fe | 1.0 | 56 | 100 | ∘ |
| Example 4 | Au | 1.0 | Cr | 1.0 | 76 | 100 | ∘ |
| Example 5 | Au | 1.0 | Zn | 1.0 | 70 | 100 | ∘ |
| Example 6 | Au | 1.0 | Al | 1.0 | 89 | 95 | ∘ |
| Example 7 | Ag | 1.0 | Fe | 1.0 | 80 | 100 | ∘ |
| Comparative | — | — | — | — | 0 | 100 | x |
| example 1 | | | | | | | |
| Comparative | — | — | Fe | 1.0 | 0 | 100 | x |
| example 2 | | | | | | | |
| Comparative | Au | 1.0 | — | — | 0 | 68 | ∘ |
| example 3 | | | | | | | |
| Comparative | Au | 1.0 | Fe | 0.01 | 7 | 68 | ∘ |
| example 4 | | | | | | | |
| Comparative | Au, Ag | 1.0 each | — | — | 0 | 68 | ∘ |
| example 5 | | | | | | | |
| Comparative | — | — | Fe, Al | 1.0 each | 0 | 100 | x |
| example 6 | | | | | | | |

*¹Atomic percentage with respect to nickel
*²Value relative to Comparative Example 1 (100)

Table 1 shows that the multilayer ceramic capacitors in which the internal electrodes contain nickel as a main component element and further contain the noble metal element and the alloying base metal element and in which 10 or more segregation sites of the alloying base metal element per layer are present in the capacitance-forming part have a large capacitance and high insulation reliability.

On the other hand, it can be seen that the multilayer ceramic capacitors according to Comparative Examples 1, 2, and 6, which do not contain the noble metal element in the internal electrodes, have a large capacitance but insufficient insulation reliability.

Furthermore, it can be seen that the multilayer ceramic capacitors according to Comparative Examples 3 and 5, in which the internal electrodes contain the noble metal element but do not contain the alloying base metal element, and the multilayer ceramic capacitor according to Comparative Example 4, in which the internal electrodes contain the noble metal element and the alloying base metal element but the number of segregation sites of the alloying base metal element is small, all have high insulation reliability but a very low capacitance.

The present description also discloses the following technique.

### (Appendant 1)

A multilayer ceramic capacitor comprising:
a multilayer chip including
   a plurality of dielectric layers formed of a dielectric ceramic and internal electrodes disposed on upper and lower surfaces of each of the dielectric layers in a lamination direction, a main component element of which internal electrodes is nickel, and which internal electrodes further contain noble metal element(s) and base metal element(s) that form(s) an alloy with nickel,
wherein the internal electrodes are alternately extracted to and exposed on respective extraction faces facing opposite to each other in a length direction; and
external electrodes that electrically interconnect the internal electrodes extracted onto the extraction faces of the multilayer chip,
wherein, in a cross section of layers of the internal electrodes taken along a line perpendicular to the extraction faces, which line passes through a center area of the multilayer chip in a width direction perpendicular to the lamination direction and the length direction, 10 or more segregation sites of the base metal element per layer are present in an observed region located in a capacitance-forming part in which the internal electrodes adjacent to each other in the lamination direction overlap, wherein each segregation site is a region where a concentration of the base metal element is higher than in a region adjacent in the length direction in the internal electrodes.

### (Appendant 2)

The multilayer ceramic capacitor according to Claim 1, wherein a ratio of a total of dimensions of the segregation sites of the base metal element in the length direction per layer to a dimension of the region located in the capacitance-forming part in the length direction is less than ½.

### (Appendant 3)

The multilayer ceramic capacitor according to (Appendant 1) or (Appendant 2), wherein the internal electrodes have, in a portion other than the segregation sites of the base metal element located in the capacitance-forming part, a noble metal element concentrated region, which has an atomic percentage of the noble metal element higher than that of a central portion in a thickness direction, near interfaces with the dielectric layers, and the atomic percentage of the noble metal element satisfies (the noble metal element concentrated region)>(the central portion in the thickness direction of the portion other than the segregation sites of the base metal element)>(the segregation sites of the base metal element).

### (Appendant 4)

The multilayer ceramic capacitor according to any one of (Appendant 1) to (Appendant 3), wherein the internal electrodes have, in a portion other than the segregation sites of the base metal element located in the capacitance-forming part, a base metal element concentrated region, which has an atomic percentage of the base metal element higher than that of a central portion in a thickness direction, near interfaces with the dielectric layers, and the atomic percentage of the base metal element satisfies (the segregation sites of the base metal element)>(the base metal element concentrated region)>(the central portion in the thickness direction of the portion other than the segregation sites of the base metal element).

### (Appendant 5)

The multilayer ceramic capacitor according to any one of (Appendant 1) to (Appendant 4), wherein the base metal element is at least one selected from iron (Fe), aluminum (Al), zinc (Zn), chromium (Cr), copper (Cu), tin (Sn), titanium (Ti), germanium (Ge), indium (In), and magnesium (Mg).

### (Appendant 6)

The multilayer ceramic capacitor according to any one of (Appendant 1) to (Appendant 5), wherein a total amount of the base metal element(s) contained in the internal electrodes is 0.03 atomic percent or more and 3.0 atomic percent or less with respect to nickel.

### (Appendant 7)

The multilayer ceramic capacitor according to any one of (Appendant 1) to (Appendant 6), wherein a total amount of the noble metal element(s) contained in the internal electrodes is 0.01 atomic percent or more and 5.0 atomic percent or less with respect to nickel.

### INDUSTRIAL FIELD OF APPLICATION

The present invention can provide a multilayer ceramic capacitor with high insulation reliability and a large capacitance. Such a multilayer ceramic capacitor is useful in that it can be suitably used for a high-frequency communication system including a mobile phone because a large capacitance can be obtained even with a small size and high insulation reliability can be maintained even with a small size.

### DESCRIPTION OF THE SYMBOLS

100 multilayer ceramic capacitor
10 dielectric layer
20, 20a, 20b internal electrode
21 region (of internal electrode) located in capacitance-forming part
22 segregation site of alloying base metal element
23 alloy portion of nickel and noble metal element
30 multilayer chip
40a, 40b extraction face
50 cover portion
60 side margin portion
70a, 70b external electrode

What is claimed:

1. A multilayer ceramic capacitor comprising:
a multilayer chip including
a plurality of dielectric layers formed of a dielectric ceramic and internal electrodes disposed on upper and lower surfaces of each of the dielectric layers in a lamination direction, a main component element of which internal electrodes is nickel, and which internal electrodes further contain noble metal element(s) and base metal element(s) that form(s) an alloy with nickel,
wherein the internal electrodes are alternately extracted to and exposed on respective extraction faces facing opposite to each other in a length direction; and
external electrodes that electrically interconnect the internal electrodes extracted onto the respective extraction faces of the multilayer chip,
wherein, in a cross section of layers of the internal electrodes taken along a line perpendicular to the extraction faces, which line passes through a center area of the multilayer chip in a width direction perpendicular to the lamination direction and the length direction, 10 or more segregation sites of the base metal element per layer are present in an observed region located in a capacitance-forming part in which the internal electrodes adjacent to each other in the lamination direction overlap, wherein each segregation site is a region where a concentration of the base metal element is higher than in a region adjacent in the length direction in the internal electrodes.

2. The multilayer ceramic capacitor according to claim 1, wherein a ratio of a total of dimensions of the segregation sites of the base metal element in the length direction per layer to a dimension of the region located in the capacitance-forming part in the length direction is less than ½.

3. The multilayer ceramic capacitor according to claim 1, wherein the internal electrodes have, in a portion other than the segregation sites of the base metal element located in the capacitance-forming part, a noble metal element concentrated region, which has an atomic percentage of the noble metal element higher than that of a central portion in a thickness direction, near interfaces with the dielectric layers, and the atomic percentage of the noble metal element satisfies (the noble metal element concentrated region)>(the central portion in the thickness direction of the portion other than the segregation sites of the base metal element)>(the segregation sites of the base metal element).

4. The multilayer ceramic capacitor according to claim 1, wherein the internal electrodes have, in a portion other than the segregation sites of the base metal element located in the capacitance-forming part, a base metal element concentrated region, which has an atomic percentage of the base metal element higher than that of a central portion in a thickness direction, near interfaces with the dielectric layers, and the atomic percentage of the base metal element satisfies (the segregation sites of the base metal element)>(the base metal element concentrated region)>(the central portion in the thickness direction of the portion other than the segregation sites of the base metal element).

5. The multilayer ceramic capacitor according to claim 1, wherein the base metal element is at least one selected from iron (Fe), aluminum (Al), zinc (Zn), chromium (Cr), copper (Cu), tin (Sn), titanium (Ti), germanium (Ge), indium (In), and magnesium (Mg).

6. The multilayer ceramic capacitor according to claim 1, wherein a total amount of the base metal element(s) contained in the internal electrodes is 0.03 atomic percent or more and 3.0 atomic percent or less with respect to nickel.

7. The multilayer ceramic capacitor according to claim 1, wherein a total amount of the noble metal element(s) contained in the internal electrodes is 0.01 atomic percent or more and 5.0 atomic percent or less with respect to nickel.
